(19) United States
(12) Patent Application Publication
(10) Pub. No.: US 2025/0385352 A1
(43) Pub. Date: Dec. 18, 2025

(54) CYLINDRICAL BATTERY AND METHOD FOR PRODUCING CYLINDRICAL BATTERY

(71) Applicant: FDK CORPORATION, Tokyo (JP)

(72) Inventors: Yuji YOKOMAKU, Tokyo (JP); Hiroshi YAHATA, Tokyo (JP); Tsukasa MANO, Tokyo (JP); Susumu ASAKI, Tokyo (JP)

(73) Assignee: FDK CORPORATION, Tokyo (JP)

(21) Appl. No.: 19/234,293

(22) Filed: Jun. 11, 2025

(30) Foreign Application Priority Data
Jun. 13, 2024 (JP) 2024-095586

(51) Int. Cl. H01M 50/169; H01M 6/16; H01M 10/0525; H01M 50/107; H01M 50/119; H01M 50/152

(52) U.S. Cl. CPC H01M 50/169; H01M 6/16; H01M 10/0525; H01M 50/107; H01M 50/119; H01M 50/152

(57) ABSTRACT

A cylindrical battery includes a battery element, an outer can having a bottomed cylindrical shape with an opening on one side, a sealing body that seals the opening of the outer can, and a welded portion in which the outer can and the sealing body are welded. The outer can houses the battery element, and the welded portion extends in a first direction along a boundary between the outer can and the sealing body. A value obtained by dividing a maximum welding depth from an outermost surface of the welded portion in the first direction by a maximum thickness of a thickness of the outer can and a thickness of the sealing body is 0.4 or more and 1.5 or less.

### CROSS-REFERENCE TO RELATED APPLICATIONS

This application is based on and claims priority under 35 USC 119 from Japanese Patent Application No. 2024-095586 filed on Jun. 13, 2024, the entire content of which is incorporated herein by reference.

### TECHNICAL FIELD

The present invention relates to a cylindrical battery and a method for manufacturing the cylindrical battery.

### BACKGROUND ART

There are a known technique of enclosing, with a sealing plate, an opening of a cylindrical outer can in which a positive electrode, a negative electrode, and the like are housed, and a technique of joining an outer periphery of the sealing plate shaped to match the opening of the outer can to an inner wall of the opening of the outer can by laser welding (Patent Literature 1).

### CITATION LIST

### Patent Literature

Patent Literature 1: JP2021-122842A

### SUMMARY OF INVENTION

In a cylindrical battery in which an outer can housing a battery element is sealed with a sealing body, for example, the outer can and the sealing body are welded using a method such as laser welding. In a cylindrical battery, when abnormal heat generation occurs due to an internal short circuit of the battery element, a physical impact, or the like, an internal pressure in the outer can sealed with the sealing body may increase. In the cylindrical battery, if a welding strength between the outer can and the sealing body is not sufficient, when the internal pressure increases, a welded portion cannot withstand the internal pressure, which may cause rupture or the like of the cylindrical battery.

One aspect of non-limiting embodiments of the present disclosure relates to providing a cylindrical battery excellent in welding strength between an outer can and a sealing body.

Aspects of certain non-limiting embodiments of the present disclosure address the features discussed above and/or other features not described above. However, aspects of the non-limiting embodiments are not required to address the above features, and aspects of the non-limiting embodiments of the present disclosure may not address features described above.

According to an embodiment of the present disclosure, there is provided a cylindrical battery, including a battery element; an outer can having a bottomed cylindrical shape with an opening on one side, the outer can housing the battery element; a sealing body that seals the opening of the outer can; and a welded portion in which the outer can and the sealing body are welded, the welded portion extending in a first direction along a boundary between the outer can and the sealing body, in which a value obtained by dividing a maximum welding depth from an outermost surface of the welded portion in the first direction by a maximum thickness of a thickness of the outer can and a thickness of the sealing body is 0.4 or more and 1.5 or less.

According to another embodiment of the present disclosure, there is provided a method for producing a cylindrical battery

In one aspect, it is possible to provide a cylindrical battery excellent in welding strength between an outer can and a sealing body.

### BRIEF DESCRIPTION OF DRAWINGS

Exemplary embodiment(s) of the present invention will be described in detail based on the following figures, in which:

FIG. 1 is a diagram illustrating an example of a cylindrical battery; and

FIG. 2 is a diagram illustrating an example of an outer can and a sealing body welded to each other.

### DESCRIPTION OF EMBODIMENTS

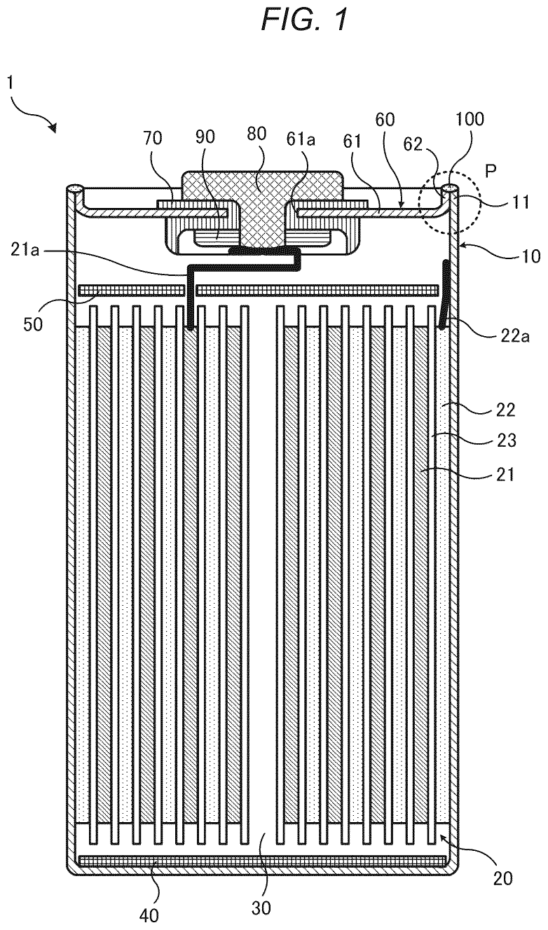

FIG. 1 is a diagram illustrating an example of a cylindrical battery. FIG. 1 is a schematic cross-sectional view of the example of the cylindrical battery.

As an example, a cylindrical battery 1 illustrated in FIG. 1 includes an outer can 10, a battery element 20, an electrolyte 30, an insulating plate 40, an insulating plate 50, a sealing body 60, a gasket 70, a positive electrode terminal 80, and a washer 90.

The cylindrical battery 1 may be a primary battery such as a lithium battery, or may be a secondary battery such as a lithium ion battery.

The outer can 10 is a conductive container having a bottomed cylindrical shape with an opening on one side 11. The outer can 10 is made of a material such as steel, nickel-plated steel, or stainless steel.

The battery element 20 is an example of a power generation element housed in the outer can 10. FIG. 1 illustrates, as an example, the battery element 20 including a sheet-shaped positive electrode 21, a sheet-shaped negative electrode 22, and a sheet-shaped separator 23. The battery element 20 has a so-called spiral electrode structure in which the positive electrode 21 and the negative electrode 22 are spirally wound with the separator 23 interposed therebetween.

The positive electrode 21 of the battery element 20 is made of a positive electrode material containing a positive electrode active material. For example, when the cylindrical battery 1 is a lithium battery, manganese dioxide or the like is used as the positive electrode active material. For example, when the cylindrical battery 1 is a lithium ion battery, lithium cobalt oxide or the like is used as the positive electrode active material. The positive electrode 21 may be formed by laminating the positive electrode material on a stainless steel expanded metal, which functions as a current collector, or the like. A conductive positive electrode tab 21a is connected to the positive electrode 21.

The negative electrode 22 of the battery element 20A is made of a negative electrode material containing a negative electrode active material. For example, when the cylindrical battery 1 is a lithium battery, or when the cylindrical battery 1 is a lithium ion battery, lithium or the like is used as the negative electrode active material. Examples of the negative electrode material containing the negative electrode active material include metallic lithium and a lithium alloy such as a lithium aluminum alloy. The negative electrode 22 may be formed by laminating the negative electrode material on a copper foil, which functions as a current collector, or the like. A conductive negative electrode tab 22a is connected to the negative electrode 22.

The positive electrode 21 and the negative electrode 22 are wound with the separator 23 interposed therebetween. The separator 23 is made of a polyolefin-based or cellulose-based porous film, woven fabric, nonwoven fabric, or the like.

As the electrolyte 30 of the cylindrical battery 1, a nonaqueous organic electrolyte obtained by dissolving a lithium electrolyte salt in an organic solvent is used. As the lithium electrolyte salt, for example, lithium trifluoromethanesulfonate is used. Examples of the organic solvent include ethylene carbonate, propylene carbonate, and 1,2-dimethoxyethane.

In the outer can 10, for example, the insulating plate 40 and the insulating plate 50 are provided at the bottom of the outer can 10 and the top of the battery element 20 to be housed, respectively.

The sealing body 60 includes, for example, a disk-shaped or annular bottom plate portion 61 having an opening 61a at a center thereof and a side wall portion 62 rising from an outer peripheral edge of the bottom plate portion 61. The gasket 70 is made of an insulating material such as resin. The positive electrode terminal 80 and the washer 90 are made of a conductive material such as metal. The positive electrode terminal 80 and the washer 90 are fixed to the opening 61a provided in the bottom plate portion 61 of the sealing body 60 via the gasket 70.

The positive electrode tab 21a connected to the positive electrode 21 of the battery element 20 is connected to the positive electrode terminal 80 fixed to the sealing body 60 together with the washer 90 via the gasket 70. The negative electrode tab 22a connected to the negative electrode 22 of the battery element 20 is connected to an inner wall of the outer can 10. The outer can 10 (for example, a part of a bottom surface thereof) functions as a negative electrode terminal.

The sealing body 60 is fitted to the opening on the one side 11 of the outer can 10. Further, the side wall portion 62 of the sealing body 60 is welded to the opening on the one side 11 of the outer can 10. The outer can 10 and the sealing body 60 are mechanically connected and fixed to each other by a welded portion 100 formed by welding. Accordingly, the outer can 10 in which the battery element 20 is housed together with the electrolyte 30 is sealed and enclosed by the sealing body 60 to which the positive electrode terminal 80 and the washer 90 are fixed via the gasket 70.

The cylindrical battery 1 described above is produced, for example, using the following method.

The bottomed cylindrical outer can 10, the sheet-shaped positive electrode 21, the sheet-shaped negative electrode 22, and the sheet-shaped separator 23 are prepared, respectively. The prepared positive electrode 21, negative electrode 22, and separator 23 are spirally wound to manufacture the battery element 20 having a spiral electrode structure.

The produced battery element 20 is inserted and housed into the outer can 10 from the opening on the one side 11. Before the battery element 20 is housed, the insulating plate 40 is provided at the bottom portion of the outer can 10. After the battery element 20 is housed, the insulating plate 50 is provided above the battery element 20 in the outer can 10.

The sealing body 60 to which the positive electrode terminal 80 and the washer 90 are fixed via the gasket 70 is prepared. The positive electrode tab 21a connected to the positive electrode 21 of the battery element 20 is connected to the positive electrode terminal 80. The negative electrode tab 22a connected to the negative electrode 22 of the battery element 20 is connected to the inner wall of the outer can 10.

The predetermined electrolyte 30 is injected into the outer can 10 housing the battery element 20 connected as described above. The sealing body 60 is fitted to the opening on the one side 11 of the outer can 10. The side wall portion 62 of the sealing body 60 and the one side 11 of the outer can 10 are welded using a method such as laser welding to form the welded portion 100. Accordingly, a structure of an enclosed container is provided in which the outer can 10 is sealed by the sealing body 60 provided with the gasket 70, the positive electrode terminal 80, and the washer 90.

For example, the cylindrical battery 1 is produced using such a method.

For example, when the cylindrical battery 1 is a lithium battery or a lithium ion battery, lithium is incorporated into the positive electrode 21 from the negative electrode 22 through the separator 23 by ion conduction during discharge. When the cylindrical battery 1 is a rechargeable battery such as a lithium ion battery, lithium is incorporated into the negative electrode 22 from the positive electrode 21 through the separator 23 by ion conduction during charging. In the cylindrical battery 1, for example, a discharging operation or a charging and discharging operation is realized by such ion conduction of lithium.

In the cylindrical battery 1 as described above, when an internal short circuit occurs between the positive electrode 21 and the negative electrode 22 of the battery element 20 or a physical impact is applied from the outside due to falling or the like, abnormal heat generation may occur. When abnormal heat generation occurs, in the enclosed container formed by the outer can 10, the sealing body 60, and the like, gas generation, gas thermal expansion, and the like due to evaporation of the electrolyte 30 may be caused, and an internal pressure in the enclosed container may increase. In the cylindrical battery 1, if the welding strength between the outer can 10 and the sealing body 60 is not sufficient, when the internal pressure increases, the welded portion 100 between the outer can 10 and the sealing body 60 cannot withstand the internal pressure, which may cause rupture or ignition of the cylindrical battery 1.

Although not illustrated here, in the cylindrical battery 1, it is also known to provide a gas discharge valve (also referred to as an “explosion-proof valve” or the like) on the sealing body 60, and when the internal pressure in the enclosed container formed by the outer can 10, the sealing body 60, and the like increases, the gas discharge valve is opened to discharge the internal gas to the outside. The valve working pressure of the gas discharge valve is preferably in the range of 2.2 MPa to 5 MPa. However, if the welding strength between the outer can 10 and the sealing body 60 is not sufficient and the welded portion 100 cannot withstand the internal pressure before the gas discharge valve is opened, the cylindrical battery 1 may rupture.

In addition, if the welding strength between the outer can 10 and the sealing body 60 is not sufficient, when an impact is applied due to falling or the like, cracks or the like may occur in the welded portion 100, and the performance of the cylindrical battery 1 may be deteriorated due to leakage of the electrolyte 30, mixing of moisture, or the like.

In view of the above points, the cylindrical battery 1 excellent in welding strength between the outer can 10 and the sealing body 60 is implemented by adopting the following configuration.

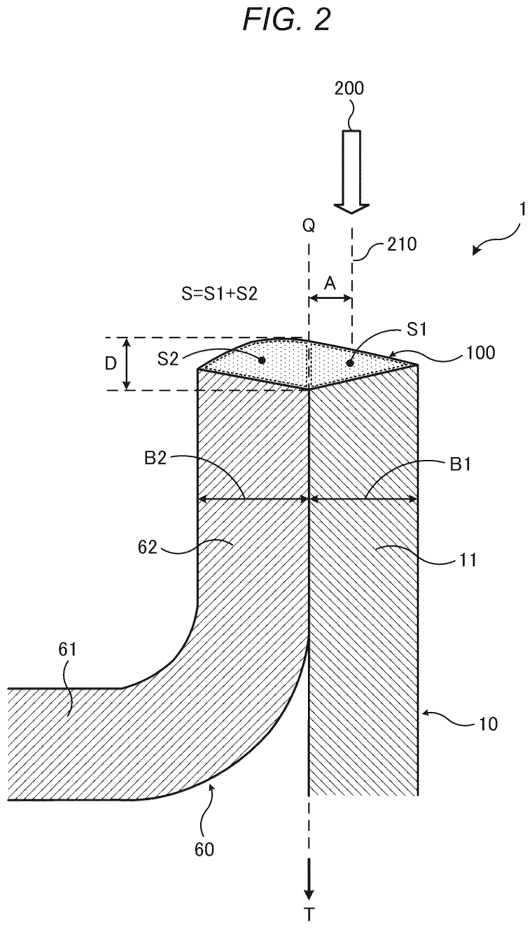

FIG. 2 is a diagram illustrating an example of the welded outer can and sealing body. FIG. 2 schematically illustrates an enlarged view of a portion P in FIG. 1.

As illustrated in FIG. 2, the sealing body 60 is fitted to the opening on the one side 11 of the outer can 10. The side wall portion 62 of the sealing body 60 and the one side 11 of the outer can 10 are laser-welded, for example. The outer can 10 and the sealing body 60 are welded and fixed by the welded portion 100 formed by laser welding.

In the laser welding, a structure in which the sealing body 60 is fitted to the outer can 10 is irradiated with laser light 200. The laser light 200 is emitted such that an optical axis 210 during the irradiation is positioned on at least one of the outer can 10 or the sealing body 60.

For example, the laser light 200 is emitted such that the optical axis 210 is positioned on any one of the outer can 10 and the sealing body 60. As an example, when the outer can 10 and the sealing body 60 are made of materials having different thermal conductivities, the laser light 200 is emitted such that the optical axis 210 is positioned on the outer can 10 or the sealing body 60 that is made of a material having a larger thermal conductivity and is less likely to be melted by heating due to irradiation with the laser light 200. That is, the laser light 200 is emitted such that the optical axis 210 is positioned on a predetermined one of the outer can 10 side and the sealing body 60 side with respect to a boundary Q between the outer can 10 and the sealing body 60. FIG. 2 illustrates, as an example, a case in which the optical axis 210 of the laser light 200 is positioned on the outer can 10 side by a distance A with respect to the boundary Q between the outer can 10 and the sealing body 60.

The position of the optical axis 210 of the laser light 200 illustrated in FIG. 2 is an example. The position of the optical axis 210 of the laser light 200 may be set on the outer can 10 side with respect to the boundary Q, may be set on the sealing body 60 side with respect to the boundary Q, or may be set on the boundary Q. However, when the position of the optical axis 210 of the laser light 200 is set on the boundary Q, attention should be paid to the laser light 200 passing through the boundary Q and reaching the inside of the container. When the position of the optical axis 210 of the laser light 200 is set to any one of the outer can 10 side and the sealing body 60 side with respect to the boundary Q, for example, is set on the one side that is less likely to be melted, it is possible to avoid the laser light 200 from passing through the boundary Q and reaching the inside of the container, and it is possible to relatively increase a cross-sectional area (welding area S, S1, or S2 described later) of the welded portion 100 to be formed and to relatively decrease a depth (a welding depth D described later).

The welded portion 100 formed by the irradiation with the laser light 200 extends in a direction T (first direction) along the boundary Q between the outer can 10 and the sealing body 60 inside the outer can 10 and the sealing body 60. Here, a maximum welding depth from an outermost surface of the welded portion 100 in the direction T is defined as the welding depth D of the welded portion 100.

An area of the welded portion 100 in a cross section when the welded portion 100 is cut in the direction T, that is, in a cross section orthogonal to a plane of the boundary Q as illustrated in FIG. 2 is defined as the welding area S of the welded portion 100. Here, in the welded portion 100, an area on the outer can 10 side with respect to the boundary Q is defined as the welding area S1, and an area on the sealing body 60 side with respect to the boundary Q is defined as the welding area S2. The welding area S of the welded portion 100 is the sum of the welding area S1 on the outer can 10 side and the welding area S2 on the sealing body 60 side with respect to the boundary Q, that is, S=S1+S2.

In the laser welding, the outer can 10 and the sealing body 60 are welded to each other by, for example, performing irradiation with the laser light 200 using a laser welding machine while blowing nitrogen gas onto the outer can 10 and the sealing body 60 to be welded. For example, the outer can 10 and the sealing body 60 are welded to each other by performing irradiation with the laser light 200 around the circumference while blowing nitrogen gas. For example, since an irradiation start portion of the laser light 200 consumes energy to warm the sealing body 60 or the outer can 10, an overlap angle at which the laser light 200 is applied twice to the irradiation start portion of the laser light 200 may be provided in order to achieve uniformity of welding. In the laser welding, conditions such as a position of the optical axis 210 of the laser light 200, a laser output, a moving (welding) speed, an overlap angle, and a nitrogen gas blowing amount during welding are set.

In the laser welding, in addition to the position of the optical axis 210 of the laser light 200, conditions such as the laser output, the welding speed, the overlap angle, and the nitrogen gas blowing amount during welding are adjusted, whereby the shape of the welded portion 100, that is, the welding depth D and the welding area S (welding areas S1 and S2) are adjusted. Under these conditions, the amount of thermal energy to be applied to the outer can 10 and the sealing body 60 to be welded is adjusted, and the welding depth D and the welding area S (or S1 and S2) of the welded portion 100 are adjusted.

In the cylindrical battery 1, if a thickness of the outer can 10 (the one side 11 thereof) is B1 and a thickness of the sealing body 60 (the side wall portion 62 thereof) is B2, the welded portion 100 is formed such that a value obtained by dividing the welding depth D (the maximum welding depth from the outermost surface) of the welded portion 100 of the outer can 10 and the sealing body 60 by the maximum thickness (Max(B1, B2)) of the thickness B1 and the thickness B2 is 0.4 or more and 1.5 or less. That is, in the cylindrical battery 1, the welded portion 100 satisfying a relation in the following Equation (1) is formed.

$$1.5 \geq D / Max ( B 1 , B 2 ) \geq 0.4 \qquad ( 1 )$$

The conditions during laser welding (the position of the optical axis 210 of the laser light 200, the laser output, the welding speed, the overlap angle, the nitrogen gas blowing amount during welding, and the like) are adjusted to from the welded portion 100 as described above.

In the cylindrical battery 1, the formation of the welded portion 100 satisfying the relation in Equation (1) enables the outer can 10 and the sealing body 60 to be welded with excellent strength, and rupture or the like during high temperatures or over-discharge (forced discharge) can be prevented.

Here, in the cylindrical battery 1, in order to satisfy the relation in Equation (1), it is not necessary to excessively increase the welding depth D or to excessively perform irradiation with the laser light 200 in order to increase the welding depth D. In other words, it can be said that in the cylindrical battery 1, if the relation in Equation (1) is satisfied, it is not necessary to excessively increase the welding depth D or to excessively perform irradiation with the laser light 200 to increase the welding depth D. This is due to the following reason.

For example, as a method for increasing the welding strength between the outer can 10 and the sealing body 60, it is conceivable to increase the welding depth D of the welded portion 100 (in other words, to increase a welding amount or the welding area S). However, in this case, during the laser welding of the outer can 10 and the sealing body 60, it is necessary to apply a large amount of thermal energy to the outer can 10 and the sealing body 60 by performing irradiation with the laser light 200, and the application of such a large amount of thermal energy may cause deformation of the resin gasket 70, evaporation of the electrolyte 30, formation of pinholes in the welded portion 100, early deterioration of the laser welding machine, and the like. If the welding depth D of the welded portion 100 is excessively increased, the height of the outer can 10 or the height of the cylindrical battery 1 may be lower than a specification.

In contrast, in the cylindrical battery 1, if the relation in Equation (1) is satisfied, it is possible to avoid excessive welding depth D of the welded portion 100 and unnecessary irradiation with the laser light 200, which may lead to the above problem caused by the application of the large amount of thermal energy. In the cylindrical battery 1, if the relation in Equation (1) is satisfied, the welding depth D of the welded portion 100 and the irradiation with the laser light 200 can be set within a range in which the above problem can be avoided, that is, a range that is not excessive. Therefore, it is possible to implement the highly safe cylindrical battery 1 which is excellent in welding strength between the outer can 10 and the sealing body 60 and can effectively prevent rupture and the like while avoiding the above problem caused by the application of the large amount of thermal energy.

In the cylindrical battery 1, the welded portion 100 is formed such that a value obtained by dividing the welding area S of the welded portion 100 (the welding area of the cross section when cut in the direction T along the boundary Q) by a square of the maximum thickness of the thickness B1 and the thickness B2 (Max(B1, B2)²) is 0.25 or more and 3.5 or less. That is, in the cylindrical battery 1, the welded portion 100 satisfying a relation in the following Equation (2) is formed.

$$3.5 \geq S / Max {( B 1 , B 2 )}^{2} \geq 0.25 \qquad ( 2 )$$

The conditions during laser welding (the position of the optical axis 210 of the laser light 200, the laser output, the welding speed, the overlap angle, the nitrogen gas blowing amount during welding, and the like) are adjusted to from the welded portion 100 as described above.

In the cylindrical battery 1, the formation of the welded portion 100 satisfying the relation in Equation (2) enables the outer can 10 and the sealing body 60 to be welded with excellent strength, and rupture or the like during high temperatures or over-discharge can be prevented.

Here, in the cylindrical battery 1, in order to satisfy the relation in Equation (2), it is not necessary to excessively increase the welding area S of the welded portion 100 or to excessively perform irradiation with the laser light 200 in order to increase the welding area S. In other words, it can be said that in the cylindrical battery 1, if the relation in Equation (2) is satisfied, it is not necessary to excessively increase the welding area S of the welded portion 100 or to excessively perform irradiation with the laser light 200 in order to increase the welding area S. In the cylindrical battery 1, if the relation in Equation (2) is satisfied, the welding area S of the welded portion 100 and the irradiation with the laser light 200 can be set within a range in which the above problem caused by the application of the large amount of thermal energy can be avoided, that is, a range that is not excessive. Accordingly, it is possible to implement the highly safe cylindrical battery 1 which is excellent in welding strength between the outer can 10 and the sealing body 60 and can effectively prevent rupture and the like while avoiding the above problem caused by the application of the large amount of thermal energy.

In addition, in the cylindrical battery 1, when the outer can 10 and the sealing body 60 are made of materials having different thermal conductivities, the welded portion 100 is formed such that a value obtained by dividing a welding area Sx (x=1 or 2) of the welding area S1 on the outer can 10 side or the welding area S2 on the sealing body 60 side with respect to the boundary Q of the welded portion 100 where a material having a smaller thermal conductivity, that is, a material that is likely to be melted is used by a square of the maximum thickness of the thickness B1 and the thickness B2 (Max(B1, B2)²) is 0.13 or more and 1.76 or less. That is, in the cylindrical battery 1, the welded portion 100 satisfying a relation in the following Equation (3) is formed.

$$1.76 \geq Sx / Max {( B 1 , B 2 )}^{2} \geq 0.13 \qquad ( 3 )$$

In Equation (3), x is 1 or 2, and is 1 when the outer can 10 is made of a material having a thermal conductivity smaller than that of the sealing body 60, and is 2 when the sealing body 60 is made of a material having a thermal conductivity smaller than that of the outer can 10.

The conditions during laser welding such as the position of the optical axis 210 of the laser light 200, the laser output, the welding speed, the overlap angle, the nitrogen gas blowing amount during welding, or the like, are adjusted to from the welded portion 100 as described above. When the outer can 10 and the sealing body 60 are made of materials having different thermal conductivities, the optical axis 210 of the laser light 200 is adjusted so as to be positioned on a side where a material having a larger thermal conductivity is used, that is, a side that is less likely to be melted by heating due to irradiation with the laser light 200.

When the optical axis 210 of the laser light 200 is adjusted to such a position, the welding area Sx on the outer can 10 side or the sealing body 60 side where the material having a smaller thermal conductivity, that is, the material that is likely to be melted is used tends to be relatively large, and the welding depth D of the welded portion 100 tends to be relatively shallow. In the cylindrical battery 1, even if the welding depth D of the welded portion 100 is relatively shallow, the welding strength between the outer can 10 and the sealing body 60 can be ensured by relatively increasing the welding area Sx.

In the cylindrical battery 1, the formation of the welded portion 100 satisfying the relation in Equation (3) enables the outer can 10 and the sealing body 60 to be welded with excellent strength, and rupture or the like during high temperatures or over-discharge can be prevented.

Here, in the cylindrical battery 1, in order to satisfy the relation in Equation (3), it is not necessary to excessively increase the welding area Sx (x=1 or 2) in the welded portion 100 or to excessively perform irradiation with the laser light 200 in order to increase the welding area Sx. In other words, it can be said that in the cylindrical battery 1, if the relation in Equation (3) is satisfied, it is not necessary to excessively increase the welding area Sx in the welded portion 100 or to excessively perform irradiation with the laser light 200 in order to increase the welding area Sx. In the cylindrical battery 1, if the relation in Equation (3) is satisfied, the welding area Sx in the welded portion 100 and the irradiation with the laser light 200 can be set within a range in which the above problem caused by the application of the large amount of thermal energy can be avoided, that is, a range that is not excessive. Accordingly, it is possible to implement the highly safe cylindrical battery 1 which is excellent in welding strength between the outer can 10 and the sealing body 60 and can effectively prevent rupture and the like while avoiding the above problem caused by the application of the large amount of thermal energy.

Hereinafter, Comparative Example and Examples will be described.

Here, as the cylindrical battery 1 having the configuration illustrated in FIG. 1, lithium batteries (lithium primary batteries) were formed in Comparative Example 1 and Examples 1 to 4, and the CR17335 type was set as a minimum size and the CR17500 type was set as a maximum size.

TABLE 1

| | Outer Can | Sealing body |
|---|---|---|
| Comparative | Ni-plated steel | Cr-containing ferritic |
| example 1 | | stainless steel (SUS430) |
| Example 1 | Ni-plated steel | Cr-containing ferritic |
| | | stainless steel (SUS430) |
| Example 2 | Ni-plated steel | Cr-containing ferritic |
| | | stainless steel (SUS430) |
| Example 3 | Ni-plated steel | Cr, Ni, Mo-containing |
| | | austenitic stainless |
| | | steel (SUS316) |
| Example 4 | Sn-added Cr-containing | Cr-containing ferritic |
| | ferritic stainless steel | stainless steel (SUS430) |

Table 1 illustrates combinations of materials for the outer can 10 and the sealing body 60 used in each of the cylindrical batteries 1 according to Comparative Example 1 and Examples 1 to 4.

TABLE 2

| | Outer can | Sealing body | Welding | | | | |
|---|---|---|---|---|---|---|---|
| | thickness | thickness B2 | depth D | | S/Max(B1, B2)² | Sx/Max(B1, B2)² | Forced |
| | B1 [mm] | [mm] | [mm] | D/Max(B1, B2) | (S = S1 + S2) | (x = 1 or 2) | discharge |
| Comparative | 0.3 | 0.3 | 0.080 | 0.267 | 0.09 | 0.04 | Ruptured |
| example 1 | | | | | | | |
| Example 1 | 0.3 | 0.3 | 0.120 | 0.400 | 0.25 | 0.13 | Not ruptured |
| Example 2 | 0.3 | 0.3 | 0.157 | 0.523 | 0.43 | 0.22 | Not ruptured |
| Example 3 | 0.3 | 0.3 | 0.142 | 0.473 | 0.40 | 0.22 | Not ruptured |
| Example 4 | 0.25 | 0.3 | 0.125 | 0.417 | 0.28 | 0.13 | Not ruptured |

Table 2 illustrates the thickness B1 of the outer can 10 and the thickness B2 of the sealing body 60 used in each of the cylindrical batteries 1 according to Comparative Example 1 and Examples 1 to 4. Table 2 further illustrates the welding depth D (the maximum welding depth from the outermost surface) of the welded portion 100, the value of D/Max(B1, B2), the value of S/Max(B1, B2)², and the value of Sx/Max(B1, B2)² in each of the cylindrical batteries 1 according to Comparative Example 1 and Examples 1 to 4. Table 2 also illustrates the presence or absence of rupture (“ruptured” or “not ruptured”) in the forced discharge or over-discharge tests (JIS C 8513 2020) of the cylindrical batteries 1 according to Comparative Example 1 and Examples 1 to 4.

### COMPARATIVE EXAMPLE 1

The outer can 10 was prepared which was made of nickel (Ni)-plated steel (referred to as “Ni-plated steel”) (see Table 1) and had a bottomed cylindrical shape with the opening on the one side 11. The thickness B1 of the Ni-plated steel used for the outer can 10 was 0.3 mm (see Table 2). The outer can 10 had the dimensions of the CR17335 type, with an outer diameter of 17.0 mm and a height of 33.5 mm. The thermal conductivity of Ni-plated steel is about 67 W/m/° C. (100° C.).

The sealing body 60 was prepared which was made of ferritic stainless steel containing chromium (Cr) (referred to as “Cr-containing ferritic stainless steel”), so-called SUS430 (see Table 1) and included the disk-shaped bottom plate portion 61 having the opening 61a and the side wall portion 62 on the outer peripheral edge of the bottom plate portion 61. The thickness B2 of the Cr-containing ferritic stainless steel (SUS430) used for the sealing body 60 was 0.3 mm (see Table 2). The thermal conductivity of the Cr-containing ferritic stainless steel (SUS430) is about 25.6 W/m/° C. (100° C.).

The positive electrode terminal 80 and the washer 90 were attached to the opening 61a of the sealing body 60 via the gasket 70. The insulating plate 40, the battery element 20, and the insulating plate 50 were housed in the outer can 10 from the opening on the one side 11 of the outer can 10. The positive electrode tab 21a was connected to the positive electrode terminal 80, and the negative electrode tab 22a was connected to the inner wall of the outer can 10. After the electrolyte 30 was injected, the sealing body 60 was fitted to the opening on the one side 11 of the outer can 10. Then, the one side 11 of the outer can 10 and the side wall portion 62 of the sealing body 60 fitted thereto were welded by laser welding to form the welded portion 100.

Accordingly, the cylindrical battery 1 according to Comparative Example 1 was obtained. In the cylindrical battery 1 according to Comparative Example 1, the welded portion 100 was formed by adjusting the conditions during laser welding, and the welding depth D of the formed welded portion 100 was 0.080 mm (see Table 2).

In the cylindrical battery 1 according to Comparative Example 1, Max(B1, B2)=0.3mm. In the cylindrical battery 1 according to Comparative Example 1, D/Max(B1, B2)=0.267 (see Table 2). In the cylindrical battery 1 according to Comparative Example 1, S/Max(B1, B2)²=0.09 (see Table 2), and when Sx=S2 (x=2), Sx/Max(B1, B2)²=S2/Max(B1, B2)²=0.04 (see Table 2).

When the cylindrical battery 1 according to Comparative Example 1 was subjected to a predetermined forced discharge test (JIS C 8513 2020), rupture was observed.

### EXAMPLE 1

The outer can 10 was prepared which was made of Ni-plated steel (see Table 1) and had a bottomed cylindrical shape with the opening on one side 11. The thickness B1 of the Ni-plated steel used for the outer can 10 was 0.3 mm (see Table 2). The outer can 10 had the dimensions of the CR17335 type, with an outer diameter of 17.0 mm and a height of 33.5 mm.

The sealing body 60 was prepared which was made of Cr-containing ferritic stainless steel, so-called SUS430 (see Table 1) and included the disk-shaped bottom plate portion 61 having the opening 61a and the side wall portion 62 on the outer peripheral edge of the bottom plate portion 61. The thickness B2 of the Cr-containing ferritic stainless steel (SUS430) used for the sealing body 60 was 0.3 mm (see Table 2).

The positive electrode terminal 80 and the washer 90 were attached to the opening 61a of the sealing body 60 via the gasket 70. The insulating plate 40, the battery element 20, and the insulating plate 50 were housed in the outer can 10 from the opening on one end side thereof. The positive electrode tab 21a was connected to the positive electrode terminal 80, and the negative electrode tab 22a was connected to an inner wall of the outer can 10. After the electrolyte 30 was injected, the sealing body 60 was fitted to the opening on the one side 11 of the outer can 10. Then, the one side 11 of the outer can 10 and the side wall portion 62 of the sealing body 60 fitted thereto were welded by laser welding to form the welded portion 100. In the laser welding, irradiation with the laser light 200 was performed such that the optical axis 210 of the laser light 200 was positioned on the outer can 10 side with respect to the boundary Q between the outer can 10 and the sealing body 60.

Accordingly, the cylindrical battery 1 according to Example 1 was obtained. In the cylindrical battery 1 according to Example 1, the welded portion 100 was formed by adjusting the conditions during laser welding, and the welding depth D of the formed welded portion 100 was 0.120 mm (see Table 2).

In the cylindrical battery 1 according to Example 1, Max(B1, B2)=0.3 mm. In the cylindrical battery 1 according to Example 1, D/Max(B1, B2)=0.400 (see Table 2). In the cylindrical battery 1 according to Example 1, S/Max(B1, B2)²=0.25 (see Table 2), and when Sx=S2 (x=2), Sx/Max(B1, B2)²=S2/Max(B1, B2)²=0.13 (see Table 2).

When the cylindrical battery 1 according to Example 1 was subjected to a predetermined forced discharge test (JIS C 8513 2020), no rupture was observed.

### EXAMPLE 2

The outer can 10 was prepared which was made of Ni-plated steel (see Table 1) and had a bottomed cylindrical shape with the opening on one side 11. The thickness B1 of the Ni-plated steel used for the outer can 10 was 0.3 mm (see Table 2). The outer can 10 had the dimensions of the CR17335 type, with an outer diameter of 17.0 mm and a height of 33.5 mm.

The sealing body 60 was prepared which was made of Cr-containing ferritic stainless steel, so-called SUS430 (see Table 1) and included the disk-shaped bottom plate portion 61 having the opening 61a and the side wall portion 62 on the outer peripheral edge of the bottom plate portion 61. The thickness B2 of the Cr-containing ferritic stainless steel (SUS430) used for the sealing body 60 was 0.3 mm (see Table 2).

By using the outer can 10 and the sealing body 60 as described above, and following the same procedure as in Example 1, the cylindrical battery 1 according to Example 2 was obtained, which includes the welded portion 100 formed by laser-welding the outer can 10 and the sealing body 60. In the cylindrical battery 1 according to Example 2, the welded portion 100 was formed by adjusting the conditions during laser welding, and the welding depth D of the formed welded portion 100 was 0.157 mm (see Table 2).

In the cylindrical battery 1 according to Example 2, Max(B1, B2)=0.3 mm. In the cylindrical battery 1 according to Example 2, D/Max(B1, B2)=0.523 (see Table 2). In the cylindrical battery 1 according to Example 2, S/Max(B1, B2)²=0.43 (see Table 2), and when Sx=S2 (x=2), Sx/Max(B1, B2)²=S2/Max(B1, B2)²=0.22 (see Table 2).

When the cylindrical battery 1 according to Example 2 was subjected to a predetermined forced discharge test (JIS C 8513 2020), no rupture was observed.

### EXAMPLE 3

The outer can 10 was prepared which was made of Ni-plated steel (see Table 1) and had a bottomed cylindrical shape with the opening on one side 11. The thickness B1 of the Ni-plated steel used for the outer can 10 was 0.3 mm (see Table 2). The outer can 10 had the dimensions of a CR17450 type, with an outer diameter of 17.0 mm and a height of 45.0 mm.

The sealing body 60 was prepared which was made of austenitic stainless steel containing Cr, Ni, and molybdenum (Mo) (referred to as “Cr, Ni, Mo-containing austenitic stainless steel”), so-called SUS316 (see Table 1) and included the disk-shaped bottom plate portion 61 having the opening 61a and the side wall portion 62 on the outer peripheral edge of the bottom plate portion 61. The thickness B2 of the Cr, Ni, Mo-containing austenitic stainless steel (SUS316) used for the sealing body 60 was 0.3 mm (see Table 2). The thermal conductivity of the Cr, Ni, Mo-containing austenitic stainless steel (SUS316) is about 16.7 W/m/° C. (100° C.).

By using the outer can 10 and the sealing body 60 as described above, and following the same procedure as in Example 1, the cylindrical battery 1 according to Example 3 was obtained, which includes the welded portion 100 formed by laser-welding the outer can 10 and the sealing body 60. In the cylindrical battery 1 according to Example 3, the welded portion 100 was formed by adjusting the conditions during laser welding, and the welding depth D of the formed welded portion 100 was 0.142 mm (see Table 2).

In the cylindrical battery 1 according to Example 3, Max(B1, B2)=0.3 mm. In the cylindrical battery 1 according to Example 3, D/Max(B1, B2)=0.473 (see Table 2). In the cylindrical battery 1 according to Example 3, S/Max(B1, B2)²=0.40 (see Table 2), and when Sx=S2 (x=2), Sx/Max(B1, B2)²=S2/Max(B1, B2)²=0.22 (see Table 2).

When the cylindrical battery 1 according to Example 3 was subjected to a predetermined forced discharge test (JIS C 8513 2020), no rupture was observed.

### EXAMPLE 4

The outer can 10 was prepared which was made of Cr-containing ferritic stainless steel with tin (Sn) added (referred to as “Sn-added Cr-containing ferritic stainless steel”) (see Table 1) and had a bottomed cylindrical shape with the opening on one side 11. The thickness B1 of the Sn-added Cr-containing ferritic stainless steel used for the outer can 10 was 0.25 mm (see Table 2). The outer can 10 had the dimensions of a CR17500 type, with an outer diameter of 17.4 mm and a height of 50.0 mm. The thermal conductivity of the Sn-added Cr-containing ferritic stainless steel is about 25.6 W/m/° C. (100° C.).

The sealing body 60 was prepared which was made of Cr-containing ferritic stainless steel, so-called SUS430 (see Table 1) and included the disk-shaped bottom plate portion 61 having the opening 61a and the side wall portion 62 on the outer peripheral edge of the bottom plate portion 61. The thickness B2 of the Cr-containing ferritic stainless steel (SUS430) used for the sealing body 60 was 0.3 mm (see Table 2).

By using the outer can 10 and the sealing body 60 as described above, and following the same procedure as in Example 1, the cylindrical battery 1 according to Example 4 was obtained, which includes the welded portion 100 formed by laser-welding the outer can 10 and the sealing body 60. In the cylindrical battery 1 according to Example 4, the welded portion 100 was formed by adjusting the conditions during laser welding, and the welding depth D of the formed welded portion 100 was 0.125 mm (see Table 2).

In the cylindrical battery 1 according to Example 4, Max(B1, B2)=0.3 mm. In the cylindrical battery 1 according to Example 4, D/Max(B1, B2)=0.417 (see Table 2). In the cylindrical battery 1 according to Example 4, S/Max(B1, B2)²=0.28 (see Table 2), and when Sx=S2 (x=2), Sx/Max(B1, B2)²=S2/Max(B1, B2)²=0.13 (see Table 2).

When the cylindrical battery 1 according to Example 4 was subjected to a predetermined forced discharge test (JIS C 8513 2020), no rupture was observed.

### Evaluation

From the results of Comparative Example 1 and Examples 1 to 4 described above, it was confirmed that the cylindrical batteries 1 according to Examples 1 to 4 satisfying 1.5≥D/Max(B1, B2)≥0.4, that is the relation in Equation (1), are more effectively prevented from rupturing even in the forced discharge state than the cylindrical battery 1 according to Comparative Example 1 not satisfying the relation. It can be said that in the cylindrical batteries 1, the rupture can be effectively prevented even in the forced discharge state if the welding depth D of the welded portion 100 is at least 0.120 mm or more.

It was confirmed that the cylindrical batteries 1 according to Examples 1 to 4 satisfying 3.5≥S/Max(B1, B2)²≥0.25, that is, the relation in Equation (2) are more effectively prevented from rupturing even in the forced discharge state than the cylindrical battery 1 according to Comparative Example 1 not satisfying the relation.

It was confirmed that the cylindrical batteries 1 according to Examples 1 to 4 satisfying 1.76≥Sx/Max(B1, B2)²≥0.13, that is, the relation in Equation (3) (where Sx=S2) are more effectively prevented from rupturing even in the forced discharge state than the cylindrical battery 1 according to Comparative Example 1 not satisfying the relation.

Therefore, it can be said that, by forming the welded portion 100 satisfying the relation in Equation (1), the relation in Equation (2), or the relation in Equation (3) as the welded portion 100 between the outer can 10 and the sealing body 60 formed by laser welding, the highly safe cylindrical battery 1 can be implemented which is excellent in welding strength of the welded portion 100 and can effectively prevent rupture.

The method of forming the welded portion 100 as described above is not limited to the lithium battery as described in Examples 1 to 4 and the like as long as it is a battery using a bottomed cylindrical outer can and a sealing body for sealing the outer can, and can be applied to the formation of a welded portion between an outer can and a sealing body in batteries of various forms such as a lithium ion battery, an alkaline battery, and a nickel hydrogen battery. The battery element housed in the enclosed container implemented by the outer can and the sealing body to be welded is not limited to the battery element 20 having the spiral electrode structure as illustrated in FIG. 1, and battery elements having various configurations according to the form of the battery can be adopted.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A cylindrical battery, comprising:
a battery element;
an outer can having a bottomed cylindrical shape with an opening on one side, the outer can housing the battery element;
a sealing body that seals the opening of the outer can; and
a welded portion in which the outer can and the sealing body are welded, the welded portion extending in a first direction along a boundary between the outer can and the sealing body, wherein
the following relation is satisfied:
$$1.5 \geq D / Max ( B 1 , B 2 ) \geq 0.4$$
wherein D is a maximum welding depth from an outermost surface of the welded portion, B1 is a thickness of the outer can, B2 is a thickness of the sealing body, and Max(B1, B2) is a maximum thickness of the thickness B1 and the thickness B2.

2. The cylindrical battery according to claim 1, wherein
the following relation is satisfied:
$$3.5 \geq S / Max {( B 1 , B 2 )}^{2} \geq 0.25$$
wherein S is a welding area of the welded portion in a cross section when the welded portion is cut in the first direction, and Max(B1,B2)² is a square of the maximum thickness Max(B1,B2).

3. The cylindrical battery according to claim 1, wherein
(i) a thermal conductivity of the outer can is smaller than that of the sealing body, and the following relation is satisfied:
$$1.76 \geq S 1 / Max {( B 1 , B 2 )}^{2} \geq 0.13$$
wherein S1 is a welding area on the outer can side of the welded portion in a cross section when the welded portion is cut in the first direction, and Max(B1,B2)² is a square of the maximum thickness Max(B1,B2);
or
(ii) a thermal conductivity of the sealing body is smaller than that of the outer can, and the following relation is satisfied:
$$1.76 \geq S 2 / Max {( B 1 , B 2 )}^{2} \geq 0.13$$
wherein S2 is a welding area on the sealing body side of the welded portion in a cross section when the welded portion is cut in the first direction, and Max(B1,B2)² is a square of the maximum thickness Max(B1,B2).

4. The cylindrical battery according to claim 1, wherein
the outer can is made of steel or stainless steel, and
the sealing body is made of stainless steel.

5. The cylindrical battery according to claim 4, wherein
the outer can is made of steel.

6. The cylindrical battery according to claim 4, wherein
the outer can is made of stainless steel.

7. The cylindrical battery according to claim 1, wherein
the maximum welding depth is 0.120 mm or more and 0.450 mm or less.

8. The cylindrical battery according to claim 1, wherein
the sealing body includes a bottom plate portion and a side wall portion rising from an outer periphery of the bottom plate portion,
the side wall portion is provided along an inner wall on the one side of the outer can, and
the boundary between the outer can and the sealing body is a boundary between the end portion and the side wall portion.

9. A method for producing the cylindrical battery according to claim 1, comprising:
forming the welded portion by irradiating at least one of the outer can and the sealing body with laser in the first direction.

10. The method for producing the cylindrical battery according to claim 9, wherein
(i) a thermal conductivity of the outer can is smaller than that of the sealing body, and
an optical axis of laser light during the laser irradiation is positioned at a side of the sealing body;
or
(ii) a thermal conductivity of the sealing body is smaller than that of the outer can, and
an optical axis of laser light during the laser irradiation is positioned at a side of the outer can.
